(19) United States
(12) Patent Application Publication
(10) Pub. No.: US 2017/0199911 A1
(43) Pub. Date: Jul. 13, 2017

(54) Method and Query Processing Server for Optimizing Query Execution

(71) Applicant: Huawei Technologies Co., Ltd., Shenzhen (CN)

(72) Inventors: Puneet Gupta, Bangalore (IN); V Vimal Das Kammath, Bangalore (IN)

(21) Appl. No.: 15/470,398

(22) Filed: Mar. 27, 2017

Related U.S. Application Data
(63) Continuation of application No. PCT/CN2015/079813, filed on May 26, 2015.

(30) Foreign Application Priority Data
Sep. 26, 2014 (IN) IN4736/CHE/2014

(51) Int. Cl. G06F 17/30

(52) U.S. Cl. CPC G06F 17/30463

(57) ABSTRACT

A method for optimizing query execution where the first step comprises receiving queries from user devices by a query processing server. The second step comprises providing an intermediate query execution status of at least one of the queries, nodes for executing queries and data partitions of the nodes to a user device for user interaction by the query processing server. The intermediate query execution status is provided based on query execution of queries. Then, the third step comprises receiving at least one of updated query parameters for the queries and updated queries based on intermediate query execution status by the query processing server. The fourth step comprises performing at least one of updating flow of query execution of queries based on updated query parameters to provide an updated intermediate query execution status; and executing updated queries to provide an updated intermediate query execution status.

### CROSS-REFERENCE TO RELATED APPLICATIONS

This application is a continuation of International Patent Application No. PCT/CN2015/079813, filed on May 26, 2015, which claims priority to Indian Patent Application No. IN4736/CHE/2014, filed on Sep. 26, 2014. The disclosures of the aforementioned applications are hereby incorporated by reference in their entireties.

### TECHNICAL FIELD

The present disclosure relates to the field of databases, and in particular, to a method and a query processing server for optimizing query execution.

### BACKGROUND

Generally, Big Data comprises a collection of large and complex data stored in a Big Data Store (referred to as a data store). The data store may comprise a plurality of nodes, each of which may comprise a plurality of data partitions to store the large and complex data. Additionally, each of the plurality of data partitions may comprise sub-data partitions which store the data. Each of the plurality of data partitions stores partial data and/or complete data depending on storage space. The large and complex data are stored in a form of data blocks which are generally indexed, sorted and/or compressed. Usually, the data in each of the plurality of nodes, the plurality of data partitions and sub-partitions is stored based on a storage space of each of the plurality of nodes, the plurality of data partitions and sub-partitions. The data store provides efficient tools to explore the data in the data store to provide response to one or more queries specified by a user i.e. for query execution. An example of the efficient tool is Online Analytical Processing (OLAP) tool to execute a query defined by the user. The tool helps in accessing the data which typically involves scanning the plurality of nodes, the plurality of data partitions and the sub-data partitions for query execution. In particular, for the query execution in which the query is specified by the user, the data related to the query is accessed upon scanning the plurality of nodes, the plurality of data partitions and the sub-data partitions.

Generally, upon completing the query execution, a result of scanning of each of the plurality of nodes and the plurality of data partitions is provided to a user interface for user analysis. The result of scanning is provided in a form of visual trend. The visual trend provides visualization of the data scanning progress of the query execution. The visual trend may include, but is not limited to, pie chart, bar graphs, histogram, box plots, run charts, forest plots, fan charts, and control chart. Usually, the visual trend of each of the plurality of nodes and the plurality of data partitions represents a final execution result corresponding to completion of data scanning of each of the plurality of nodes and the plurality of data partitions.

Typically, for query execution in smaller data sets, the scanning is completed within a short time span. For example, the scanning for the query execution in smaller data sets may be completed within seconds. Then, the result of scanning is provided to the user interface. For example, the query defined by the user requires viewing traffic volume of different network devices. As an example, the network devices are Gateway General Packet Radio Service (GPRS) Support Node (GGSN) devices. The GGSN devices are used for internetworking between the GPRS network and external packet switched networks. The GGSN devices provide internet access to one or more mobile data users. Generally, millions of records are generated in the network devices based on an internet surfing patterns of the one or more mobile data users. FIG. 1 shows the result of scanning on the traffic volume of the different network devices which are being provided to the user interface, in a form of visual trend, for example bar chart. The bars represent the traffic volume of different network devices D1, D2, D3, D4 and D5 which are provided to the user interface after query execution. However, there exists a problem in Big Data Environment. That is, in Big Data Environment, the scanning for the query execution may take a time span from minutes to hours. In such case, the processing involves waiting for completion of query execution. That is, the user has to wait for hours for viewing the result of scanning, and modifying the query until the query execution is completed which is tedious and non-interactive.

One such example of conventional query processing technique is batch scheduled scanning, where the queries are batched and scheduled for execution. However, the execution of batched queries is time consuming, complex and is not carried out in real-time. In such case, viewing of execution result also consumes time. Additionally, modification to the query can be performed only when the batched execution is completed which consumes time. The user cannot interact in between query execution status and results in between the query execution. The user has to wait for the completion of the query execution and till the results of the query execution is provided.

### SUMMARY

An objective of the present disclosure is to provide partial query execution status of the query execution of queries without waiting completion of entire query execution. Another objective of the present disclosure is to facilitate user interaction on the partial query execution status to update flow of the query execution. The present disclosure relates to a method for optimizing query execution. The method comprises one or more steps performed by a query processing server. The first step comprises receiving one or more queries from one or more user devices by the query processing server. The second step comprises providing an intermediate query execution status of at least one of the one or more queries, one or more nodes for executing the one or more queries and one or more data partitions of the one or more nodes to a user device for user interaction by the query processing server. The intermediate query execution status is provided based on the query execution of the one or more queries. Then, the third step comprises receiving at least one of one or more updated query parameters for the one or more queries and one or more updated queries based on the intermediate query execution status by the query processing server. The fourth step comprises performing at least one of updating flow of query execution of the one or more queries based on the one or more updated query parameters to provide an updated intermediate query execution status; and executing the one or more updated queries to provide an updated intermediate query execution status. In an embodiment, the updating flow of the query execution based on the one or more updated query parameters comprises terminating the query execution of at least one of a part of the one or more queries, a part of the one or more nodes and a part of the one or more data partitions. The updating of the flow of the query execution based on the one or more updated query parameters comprises prioritizing the query execution of at least one of a part of the one or more queries, a part of the one or more nodes and a part of the one or more data partitions. The updating of flow of the query execution based on the one or more updated query parameters comprises executing a part of the one or more queries. The part of the one or more queries is selected by the user. In an embodiment, executing the one or more updated queries comprises executing parallelly the one or more updated queries along with the one or more queries. In an embodiment, a visual trend of the intermediate query execution results is marked upon completion of a part of the query execution.

A query processing server is disclosed in the present disclosure for optimizing query execution. The query processing server comprises a receiving module, an output module, and an execution module. The receiving module is configured to receive one or more queries from one or more user devices. The output module is configured to provide an intermediate query execution status of at least one of the one or more queries, one or more nodes for executing the one or more queries and one or more data partitions of the one or more nodes to a user device for user interaction. The intermediate query execution status is provided based on the query execution of the one or more queries. The execution module is configured to receive at least one of one or more updated query parameters for the one or more queries and one or more updated queries based on the intermediate query execution status. The execution module is configured to perform at least one of update flow of query execution of the one or more queries based on the one or more updated query parameters to provide an updated intermediate query execution status; and execute the one or more updated queries to provide an updated intermediate query execution status.

A graphical user interface is disclosed in the present disclosure. The graphical user interface on a user device with a display, memory and at least one processor to execute processor-executable instructions stored in the memory is disclosed. The graphical user interface comprises electronic document displayed on the display. The displayed portion of the electronic document comprises data scan progress trend, a stop button and a visual trend. The stop button is displayed proximal to the data scan progress trend. The visualization indicates intermediate query execution status, which is displayed adjacent to the data scan progress trend. The visualization includes traffic volume trend corresponding to one or more nodes for executing the one or more queries and one or more data partitions of the one or more nodes. At least one of electronic list over a displayed electronic document is displayed in response to detecting movement of object in a direction on or near the displayed portion of the electronic document. The electronic list provides one or more query update options to update the query. In response to selection of one of one or more query update option, except stop option, at least one of node-wise results, results for updated number of nodes from one or more nodes, results of one or more nodes along with results of one or more sub-nodes or results trend of one of one or more nodes is displayed.

The present disclosure relates to a non-transitory computer readable medium including operations stored thereon that when processed by at least one processor cause a query processing server to perform one or more actions by performing the acts of receiving one or more queries from one or more user devices. Then, the act of providing an intermediate query execution status of at least one of the one or more queries, one or more nodes for executing the one or more queries and one or more data partitions of the one or more nodes to a user device for user interaction is performed. The intermediate query execution status is provided based on the query execution of the one or more queries. Next, the act of receiving at least one of one or more updated query parameters for the one or more queries and one or more updated queries based on the intermediate query execution status is performed. Then, the act of performing at least one of updating flow of query execution of the one or more queries based on the one or more updated query parameters to provide an updated intermediate query execution status; and executing the one or more updated queries to provide an updated intermediate query execution status.

The present disclosure relates to a computer program for performing one or more actions on a query processing server. The said computer program comprising code segment for receiving one or more queries from one or more user devices; code segment for providing an intermediate query execution status of at least one of the one or more queries, one or more nodes for executing the one or more queries and one or more data partitions of the one or more nodes to a user device for user interaction; code segment for receiving at least one of one or more updated query parameters for the one or more queries and one or more updated queries based on the intermediate query execution status, wherein the intermediate query execution status is provided based on the query execution of the one or more queries; and code segment for performing at least one of updating flow of query execution of the one or more queries based on the one or more updated query parameters to provide an updated intermediate query execution status; and executing the one or more updated queries to provide an updated intermediate query execution status.

The foregoing summary is illustrative only and is not intended to be in any way limiting. In addition to the illustrative aspects and features described above, further aspects, and features will become apparent by reference to the drawings and the following detailed description.

### BRIEF DESCRIPTION OF THE DRAWINGS

The novel features and characteristic of the present disclosure are set forth in the appended claims. The embodiments of the present disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings.

FIG. 1 show a diagram illustrating a bar chart showing traffic volume of different network devices in accordance with an embodiment of the prior art;

FIG. 2A shows exemplary block diagram illustrating a query processing server with processor and memory for optimizing query execution in accordance with some embodiments of the present disclosure;

FIG. 2B shows a detailed block diagram illustrating a query processing server for optimizing query execution in accordance with some embodiments of the present disclosure;

FIGS. 3A and 3B show an exemplary visual trend representing the intermediate query execution status of each of the one or more queries, the one or more nodes and the one or more data partitions in accordance with an embodiment of the present disclosure;

FIG. 4 shows an exemplary diagram to provide one or more update options during user interaction for updating the one or more queries in accordance with some embodiments of the present disclosure;

FIGS. 5A and 5B show an exemplary diagram illustrating removing a part of the query in accordance with some embodiments of the present disclosure;

FIGS. 6A and 6B show an exemplary diagram illustrating modification of a part of the query in accordance with some embodiments of the present disclosure;

FIGS. 7A and 7B show an exemplary diagram illustrating a detailed view of the intermediate query execution status of the query in accordance with some embodiments of the present disclosure;

FIGS. 8A to 8F show an exemplary diagram illustrating prediction of a final result of the intermediate query execution status of the query in accordance with some embodiments of the present disclosure;

FIGS. 9A and 9B show an exemplary diagram illustrating prioritization of a part of the query in accordance with some embodiments of the present disclosure;

FIGS. 10A and 10B show an exemplary diagram illustrating parallel execution of one or more updated queries along with the one or more queries in accordance with some embodiments of the present disclosure;

FIG. 11 shows an exemplary diagram illustrating marking a visual trend of the intermediate query execution status in accordance with some embodiments of the present disclosure;

FIG. 12 illustrates a flowchart showing method for optimizing query execution in accordance with some embodiments of the present disclosure; and

FIGS. 13A and 13B illustrate a flowchart of method for providing intermediate query execution status and query execution progress details in accordance with some embodiments of the present disclosure.

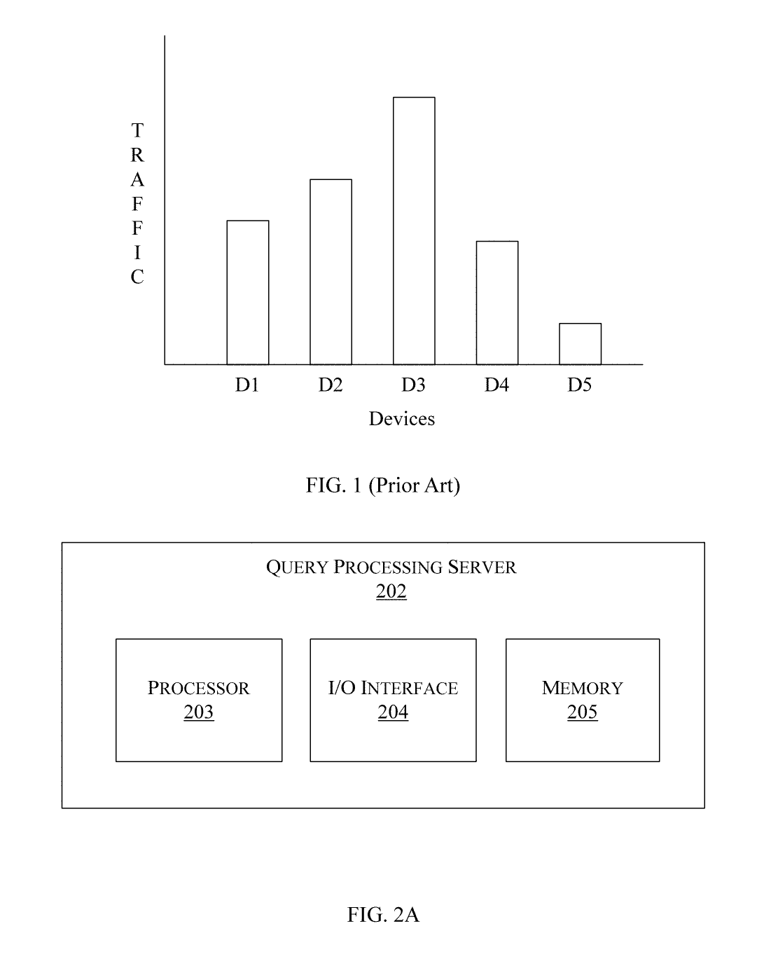

The figures depict embodiments of the present disclosure for purposes of illustration only. One skilled in the art will readily recognize from the following description that alternative embodiments of the structures and methods illustrated herein may be employed without departing from the principles of the present disclosure described herein.

### DETAILED DESCRIPTION

The foregoing has broadly outlined the features and technical advantages of the present disclosure in order that the detailed description of the present disclosure that follows may be better understood. Additional features and advantages of the present disclosure will be described hereinafter which form the subject of the claims of the disclosure. It should be appreciated by those skilled in the art that the conception and specific aspect disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Embodiments of the present disclosure relate to providing partial query execution status to a user interface during query execution. The partial execution status is provided for facilitating user interaction to update queries based on the partial execution status for optimizing query execution. In an exemplary embodiment, the partial execution status is provided to one or more user device for analyzing the status and performing updating of queries based on the partial execution status. That is, the user device provides inputs to update queries. The query execution is performed by a query processing server. The query processing server receives one or more queries from the one or more user devices. In an embodiment, the query processing server performs query execution by accessing data in one or more nodes of the query processing server and one or more data partitions of the one or more nodes. The query execution in the one or more nodes, the one or more data partitions and sub-partitions is carried out based on the data required by the one or more queries i.e. for the query execution. The partial execution status refers to an amount or percentage of data scanned status and intermediate result of the data being scanned at an intermediate level. Therefore, partial execution status of the one or more queries, the one or more nodes and the one or more data partition is provided to a user interface associated to the one or more user devices. In an embodiment, the partial execution status is provided in a form of a visual trend to the user interface. The visual trend is a representation or visualization of the data scanning progress of the query execution. The partial execution status is provided based on the query execution of the one or more queries. Based on the user interaction, at least one of the one or more queries based on the one or more updated query parameters and one or more updated queries are received by the query processing server. Based on at least one of the updated query parameters and the updated queries, at least one of following steps is performed. The step of updating flow of query execution of queries based on updated query parameters is performed to provide an updated intermediate query execution status. The step of executing updated queries is performed to provide an updated intermediate query execution status. The updating of flow of the query execution and execution of the updated queries does not terminate the execution of the original query which is received from the user device. Particularly, the same flow of query execution is maintained for the original queries received from the user device. The updating of flow of the query execution of the queries based on the updated query parameters comprises terminating the query execution of at least one of a part of the query, a part of the one or more nodes and a part of the one or more data partitions. The updating of flow of the query execution of the queries based on the updated query parameters also comprises prioritizing the query execution of at least one of a part of the query, a part of the one or more nodes and a part of the one or more data partitions. The updating of flow of the query execution of the queries based on the updated query parameters comprises executing a part of the query selected by the user. In an embodiment, execution of the updated queries comprises parallel execution of the one or more updated queries along with the queries i.e. initial queries. In an embodiment, the visual trend of the partial execution status is marked upon completion of a part of the query execution. In this way, a user is facilitated to view the partial execution status in every progress of the query execution in real-time and need not wait till the completion of the query execution for viewing the results of the query execution. Further, the user is facilitated to interact with the partial execution status in real-time, thereby reducing waiting time for the query execution to be over to analyze the query results.

Henceforth, embodiments of the present disclosure are explained with the help of exemplary diagrams and one or more examples. However, such exemplary diagrams and examples are provided for the illustration purpose for better understanding of the present disclosure and should not be construed as limitation on scope of the present disclosure.

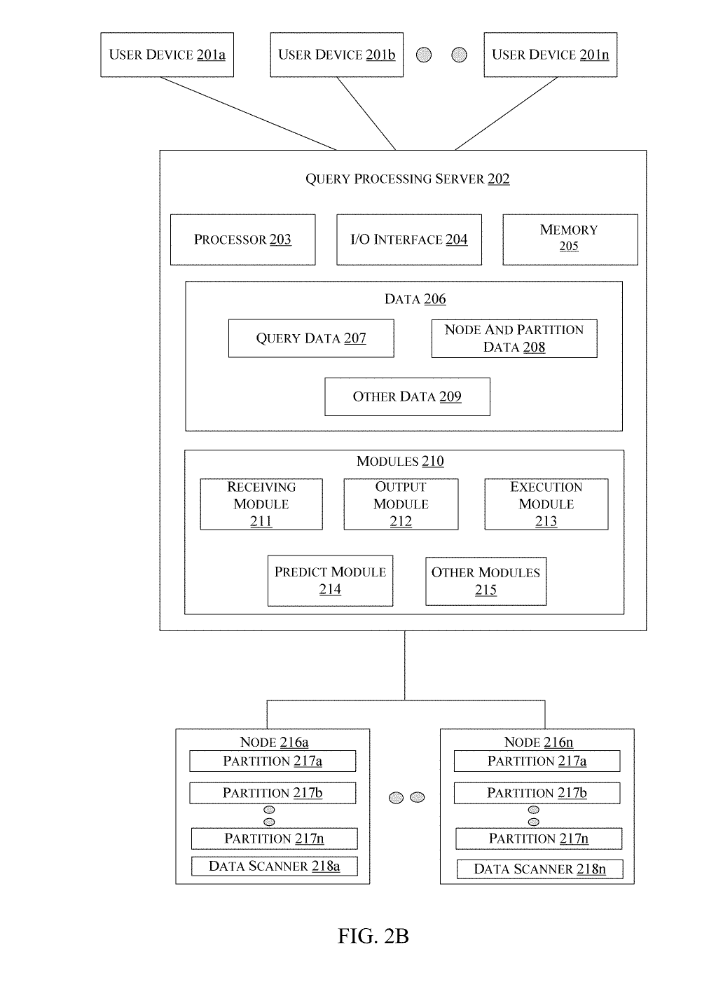

FIG. 2A shows exemplary block diagram illustrating a query processing server 202 with a processor 203 and a memory 205 for optimizing query execution in accordance with some embodiments of the present disclosure. The query processing server 202 comprises the processor 203 and the memory 205. The memory 205 is communicatively coupled to the processor 203. The memory 205 stores processor-executable instructions which on execution cause the processor 203 to perform one or more steps. The processor 203 receives one or more queries from one or more user devices. The processor 203 provides an intermediate query execution status of at least one of the one or more queries, one or more nodes for executing the one or more queries and one or more data partitions of the one or more nodes to a user device for user interaction. The intermediate query execution status is provided based on the query execution of the one or more queries. The processor 203 receives at least one of one or more updated query parameters for the one or more queries and one or more updated queries based on the intermediate query execution status. The processor 203 performs at least one of update flow of the query execution of the one or more queries based on the one or more updated query parameters to provide an updated intermediate query execution status; and execute the one or more updated queries to provide an updated intermediate query execution status.

FIG. 2B shows detailed block diagram illustrating a query processing server 202 for optimizing query execution in accordance with some embodiments of the present disclosure.

In one implementation, the query processing server 202 may be implemented in a variety of computing systems, such as a laptop computer, a desktop computer, a notebook, a workstation, a mainframe computer, a server, a network server, and the like. In an embodiment, the query processing server 202 is communicatively connected to one or more user devices 201a, 201b, . . . , 201n (collectively referred to 201) and one or more nodes 216a, . . . 216n (collectively referred to 216).

Examples of the one or more user devices 201 include, but are not limited to, a desktop computer, a portable computer, a mobile phone, a handheld device, a workstation. The one or more user devices 201 may be used by various stakeholders or end users of the organization. In an embodiment, the one or more user devices 201 are used by associated users to raise one or more queries. Also, the users are facilitated to interact with an intermediate query execution status provided by the query processing server 202 for inputting updated query parameters for the one or more queries and updated queries using the one or more user devices 201. In an embodiment, the users are enabled to interact through a user interface (not shown in FIG. 2B) which is an interactive graphical user interface of the one or more user devices 201. The user interaction is facilitated using input device (not shown in FIG. 2b) including, but not limited to, stylus, finger, pen shaped pointing device, keypad and any other device that can be used to input through the user interface. The users may include a person, a person using the one or more user devices 201 such as those included in this present disclosure, or such a user device itself

In one implementation, each of the one or more user devices 201 may include an input/output (I/O) interface for communicating with I/O devices (not shown in FIG. 2B). The query processing server 202 may include an I/O interface for communicating with the one or more user devices 201. The one or more user devices 201 are installed with one or more interfaces (not shown in FIG. 2B) for communicating with the query processing server 202 over a first network (not shown in FIG. 2b). Further, the one or more interfaces 204 in the query processing server 202 are used to communicate with the one or more nodes 216 over a second network (not shown in FIG. 2B). The one or more interfaces of each of the one or more user devices 201 and the query processing device 202 may include software and/or hardware to support one or more communication links (not shown) for communication. In an embodiment, the one or more user devices 201 communicate with the first network via a first network interface (not shown in FIG. 2B). The query processing server 202 communicates with the second network via a first network interface (not shown in FIG. 2B). The first network interface and the second network interface may employ connection protocols include, but not limited to, direct connect, Ethernet (e.g., twisted pair 10/100/1000 Base T), transmission control protocol/internet protocol (TCP/IP), token ring, Institute of Electrical and Electronics Engineers (IEEE) 802.11a/b/g/n/x, etc.

Each of the first network and the second network includes, but is not limited to, a direct interconnection, an e-commerce network, a peer to peer (P2P) network, local area network (LAN), wide area network (WAN), wireless network (e.g., using Wireless Application Protocol (WAP)), the Internet, Wi-Fi and such. The first network and the second network may either be a dedicated network or a shared network, which represents an association of the different types of networks that use a variety of protocols, for example, Hypertext Transfer Protocol (HTTP), TCP/IP, WAP, etc., to communicate with each other. Further, the first network and the second network may include a variety of network devices, including routers, bridges, servers, computing devices, storage devices, etc.

In an implementation, the query processing server 202 also acts as user device. Therefore, the one or more queries and the intermediate query execution status are directly received at the query processing server 202 for query execution and user interaction.

The one or more nodes 216 connected to the query processing server 202 are servers comprising a database containing data which is analyzed and scanned for executing the one or more queries received from the one or more user devices 201. Particularly, the one or more nodes 216 comprise Multidimensional Expressions (MDX) based database, Relational Database Management System (RDMS), Structured Query Language (SQL) database, Not Only Structured Query Language (NoSQL) database, semi-structured queries based database, and unstructured queries based database. Each of the one or more nodes 216 comprises one or more data partitions 217a, 217b, . . . ,217n (collectively referred to numeral 217) and at least one data scanner 218. In an embodiment, each of the one or more data partitions 217 of the one or more nodes 216 may comprise at least one sub-partition (not shown in FIG. 2B). In an embodiment, each of the one or more data partitions 217 and the at least one sub-partition of the one or more data partitions 217 are physical storage units storing partitioned or partial data. Typically, the data is partitioned and/or distributed in each of the one or more nodes 216, which is further partitioned and distributed in the one or more data partitions 217 and the at least one sub-partition for the storage. In one implementation, the data of network devices for example 5 network devices D1, D2, D3, D4 and D5 are stored in the one or more data partitions 217 of the one or more nodes 216. In an embodiment, the data is stored based on the storage space available in each of the one or more nodes 216, the one or more data partitions 217 and the sub-partitions. In an embodiment, the data is stored in the one or more nodes 216, the one or more data partitions 217 and the at least one sub-partition based on device identification (ID) of the network devices. In an embodiment, the one or more nodes 216 stores data along with data statistics of the stored data. The data statistics includes, but are not limited to, size of partition, number of records, data which is under frequent usage from each partition, and minimum, maximum, average, and sum values of records in each partition.

The data scanner 218 of each of the one or more nodes 216 is configured to scan the data in the one or more nodes 216, the one or more data partitions 217 and sub-partitions for executing the one or more queries received from the one or more user devices 201. Additionally, the data scanner 218 provides reports of data scanning results including the intermediate query execution status of each of query, the one or more nodes 216, the one or more partitions 217 and the at least one sub-partition to the query processing server 202. In an embodiment, the intermediate query execution status comprises an intermediate query execution results of the one or more queries, the one or more nodes 216, the one or more data partitions 217 and the at least one sub-partition. The intermediate query execution status comprises a query execution progress of the one or more queries, the one or more nodes 216, the one or more data partitions 217 and the at least one sub-partition. The intermediate query execution results refer to partial results of the data scanning of the one or more queries. The query execution progress refers to an amount or percentage of data scanning of the one or more queries, the one or more nodes 216, the one or more data partitions 217 and the at least one sub-partitions. In one implementation, the intermediate query execution status is provided based on parameters which include, but are not limited to, a predetermined time interval, number of rows being scanned, size of data being scanned, and rate of data being scanned. For example, in every predetermined time interval of 30 seconds the intermediate query execution status is provided. The number of rows to be scanned is 10,000 rows after which the intermediate query execution status is provided. That is, upon scanning of every 10,000 rows in the database, the intermediate query execution status is provided. The size of data is 100 megabytes (Mb) i.e. upon scanning of every 100 Mb of data the intermediate query execution status is provided. The rate of data refers to an amount or percentage or level of data being scanned, for example, upon scanning of 10% of data, the intermediate query execution status is provided.

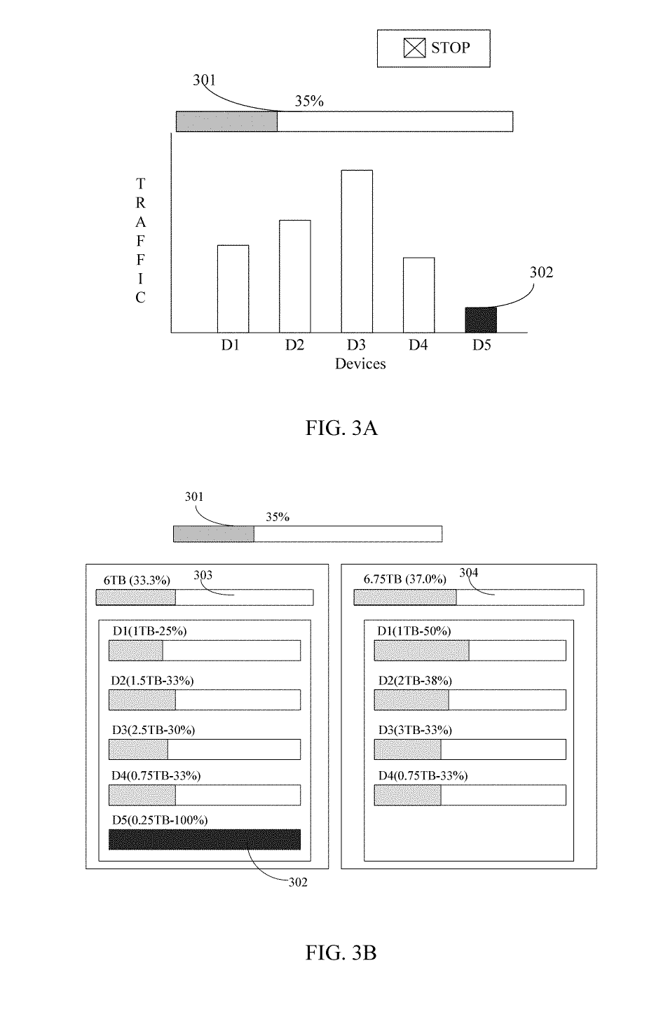

An example for providing the intermediate query execution status is illustrated herein. FIGS. 3A and 3B show an exemplary visual trend representing the intermediate query execution status of each of the one or more queries, the one or more nodes and the one or more data partitions in accordance with an embodiment of the present disclosure. For example, considering a query i.e. query 1 received from the one or more user devices 201. Consider the query 1 specifies to retrieve traffic volume of 5 network devices i.e. D1, D2, D3, D4, and D5. Assuming, the data required by the query 1 is stored in node 1 and node 2. Particularly, based on the device IDs, the data is partitioned, distributed, and stored in partitions i.e. the data of the network devices D1, D2, D3, D4 and D5 are stored in the partitions P1, P2, P3, P4 and P5 of the node 1. For example, the data of size of 1 Terabyte (TB), 1.5 TB, 2.5 TB, 0.75 TB and 0.25 TB of the network devices D1, D2, D3, D4 and D5 are stored in the partitions P1, P2, P3, P4 and P5 of the node 1. In such case, the size of the node 1 is 6 TB. Further, the data of the network devices D1, D2, D3 and D4 are also partitioned, distributed and stored in the partitions P6, P7, P8 and P9 of the node 2. For example, 1 TB, 2 TB, 3 TB and 0.75 TB of the network devices D1, D2, D3 and D4 are stored in the partitions P6, P7, P8 and P9 of the node 2. The data scanner 218a scans the data in the partitions P1 to P5 of the node 1 and the data scanner 218b scans the data in the partitions P6 to P9 of the node 2. The partition P1 of the node 1 and the partition P6 of the node 2 are scanned to retrieve the traffic volume of the network device D1. The partitions P2 of the node 1 and the partition P7 of the node 2 are scanned to retrieve the traffic volume of the network device D2 and so on. For example, after 30 minutes, an intermediate query status in the form of the visual trend is displayed on the user interface. In the illustrated FIG. 3A, visual trend of the intermediate query status of each of the query 1 and the network devices D1, D2, D3, D4 and D5 are displayed for showing the traffic volume of the network devices. The intermediate query execution result and query execution progress of the query 1 showing the traffic volume of the network devices D1-D5 are displayed. The bar 301 shows the intermediate query execution result with query execution progress of 35% of the query 1 which means 35% of the query execution is completed for the query 1. The bars of the network devices D1, D2, D3, D4 and D5 show the intermediate query execution result, i.e. traffic volume of the network devices D1, D2, D3, D4 and D5.

For example, the user wants to view the details of the intermediate query execution status of each of the nodes i.e. node 1 and node 2 and each of the partitions P1, P2, P3, P4 and P5 of the node 1 and P6, P7, P8 and P9 of the node 2. FIG. 3B shows the visual trend of the intermediate query execution status of each of the query 1, node 1, node 2 and traffic volume status of each of the network devices D1, D2, D3, D4 and D5. In the illustrated FIG. 3B, the visual trend i.e. bar 303 is the intermediate query execution status of the node 1 where the query execution progress is 33.3%. The bar 304 is the intermediate query execution status of the node 2 the query execution progress is 37.0%. The bars of the network devices D1, D2, D3, D4 and D5 of the node 1 shows the query execution progress being 25%, 33%, 30%, 33% and 100%. The bar of the network D5 numbered as 302, is marked since the query execution progress is 100% i.e. query execution of the network device D5 is completed. The bars of the network devices D1, D2, D3 and D4 of the node 2 shows the query execution progress being 50%, 38%, 33% and 33%. The intermediate query execution status of the query 1 as shown by the bar numbered 301 is based on the accumulated result of the intermediate query execution status of each of the node 1 and node 2. The intermediate query execution status of the node 1 as shown by the bar numbered 303 is based on the accumulated result of the intermediate query execution status of each of the network devices D1-D5. The intermediate query execution status of the node 2 as shown by the bar numbered 304 is based on the accumulated result of the intermediate query execution status of each of the network devices D1-D4. The bars of network devices D1, D2, D3, and D4 in the FIG. 3A is the accumulated result of the intermediate query execution status of the network devices D1-D4 from both the node 1, and the node 2.

In one implementation, query processing server 202 includes a central processing unit (“CPU” or “processor”) 203, an I/O interface 204 and the memory 205. The processor 203 of the query processing server 202 may comprise at least one data processor for executing program components and for executing user- or system-generated one or more queries. The processor 203 may include specialized processing units such as integrated system (bus) controllers, memory management control units, floating point units, graphics processing units, digital signal processing units, etc. The processor 203 may include a microprocessor, such as Advanced Micro Devices' ATHLON, DURON or OPTERON, Advance RISC Machine's application, embedded or secure processors, International Business Machine's POWERPC, Intel Corporation's CORE, ITANIUM, XEON, CELERON or other line of processors, etc. The processor 203 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc. Among other capabilities, the processor 203 is configured to fetch and execute computer-readable instructions stored in the memory 205.

The I/O interface(s) 204 may include a variety of software and hardware interfaces, for example, a web interface, a graphical user interface, etc. The interface 204 is coupled with the processor 203 and an I/O device (not shown). The I/O device is configured to receive the one or more of queries from the one or more user devices 201 via the interface 204 and transmit outputs or results for displaying in the I/O device via the interface 204.

In one implementation, the memory 205 is communicatively coupled to the processor 203. The memory 205 stores processor-executable instructions to optimize the query execution. The memory 205 may store information related to the intermediate scanning status of the data required by the one or more queries. The information may include, but is not limited to, fields of data being scanned for the query execution, constraints of data being scanned for the query execution, tables of data being scanned for the query execution, ID information of each of the one or more nodes 216, the one or more data partitions 217 and the at least one sub-partition which are used for the query execution. In an embodiment, the memory 205 may be implemented as a volatile memory device utilized by various elements of the query processing server 202 (e.g., as off-chip memory). For these implementations, the memory 205 may include, but is not limited to, random access memory (RAM), dynamic random access memory (DRAM) or static RAM (SRAM). In some embodiment, the memory 205 may include any of a Universal Serial Bus (USB) memory of various capacities, a Compact Flash (CF) memory, an Secure Digital (SD) memory, a mini SD memory, an Extreme Digital (XD) memory, a memory stick, a memory stick duo, an Smart Media Cards (SMC) memory, an Multimedia card (MMC) memory, and an Reduced-Size Multimedia Card (RS-MMC), for example, noting that alternatives are equally available. Similarly, the memory 205 may be of an internal type included in an inner construction of a corresponding query processing server 202, or an external type disposed remote from such a query processing server 202. Again, the memory 205 may support the above-mentioned memory types as well as any type of memory that is likely to be developed and appear in the near future, such as phase change random access memories (PRAMs), units, buzzers, beepers etc. The one or more units generate a notification for indicating the identified ferroelectric random access memories (FRAMs), and magnetic random access memories (MRAMs), for example.

In an embodiment, the query processing server 202 receives data 206 relating to the one or more queries from the one or more user devices 201 and the intermediate query execution status of each of the one or more nodes 216, the one or more data partitions 217 and the at least one sub-partition associated with the query execution of the one or more queries from the one or more nodes 216. In one example, the data 206 received from the one or more user devices 201 and the one or more nodes 216 may be stored within the memory 205. In one implementation, the data 206 may include, for example, query data 207, node and partition data 208 and other data 209.

The query data 207 is a data related to the one or more queries received from the one or more user devices 201. The query data 207 includes, but is not limited to, fields including sub-fields, constraints, tables, and tuples specified in the one or more queries based on which the data scanning of the one or more nodes 216 is required to be performed for execution of the one or more queries.

The node and partition data 208 is data related to the query execution of each of the one or more nodes 216, the one or more data partitions 217 and the at least one sub-partition. In one implementation, the node and partition data 208 includes the intermediate query execution status of each of the one or more nodes 216, the one or more data partitions 217 and the at least one sub-partition provided by the data scanner 218. In another implementation, the node and partition data 208 includes ID information of each of the one or more nodes 216, the one or more data partitions 217 and the at least one sub-partition involved in the query execution.

In one embodiment, the data 206 may be stored in the memory 205 in the form of various data structures. Additionally, the aforementioned data 206 may be organized using data models, such as relational or hierarchical data models. The other data 206 may be used to store data, including temporary data and temporary files, generated by the modules 210 for performing the various functions of the query processing server 202. In an embodiment, the data 206 are processed by modules 210 of the query processing server 202. The modules 210 may be stored within the memory 103.

In one implementation, the modules 210, amongst other things, include routines, programs, objects, components, and data structures, which perform particular tasks or implement particular abstract data types. The modules 210 may also be implemented as, signal processor(s), state machine(s), logic circuitries, and/or any other device or component that manipulate signals based on operational instructions. Further, the modules 210 can be implemented by one or more hardware components, by computer-readable instructions executed by a processing unit, or by a combination thereof.

The modules 210 may include, for example, a receiving module 211, an output module 212, an execution module 213 and predict module 214. The query processing server 202 may also comprise other modules 215 to perform various miscellaneous functionalities of the query processing server 202. It will be appreciated that such aforementioned modules may be represented as a single module or a combination of different modules.

In one implementation, the receiving module 211 is configured to receive the one or more queries from the one or more user devices 201. For example, considering a query i.e. query 1 raised by the user using a user device 201. The receiving module 211 receives the intermediate query execution status of each of the one or more queries, the one or more nodes 216, the one or more data partitions 217 and the at least one sub-partition from the data scanner 218. For example, considering a query i.e. query 1 to retrieve traffic volume of the five network devices D1, D2, D3, D4 and D5 received from the user devices 201. In exemplary embodiment, the intermediate query execution status of the query 1 is received from the data scanner 218.

The output module 212 provides the intermediate query execution status of each of the one or more queries, the one or more nodes 216, the one or more data partitions 217 and the at least one sub-partition in a form of the visual trend to the user interface of the one or more user devices 201. The visual trend may include, but is not limited to, pie chart, bar graphs, histogram, box plots, run charts, forest plots, fan charts, table, pivot table, and control chart. In an embodiment, the visual trend is a bar chart explained herein. FIGS. 3A and 3B show an exemplary visual trend representing the intermediate query execution status for the query execution.

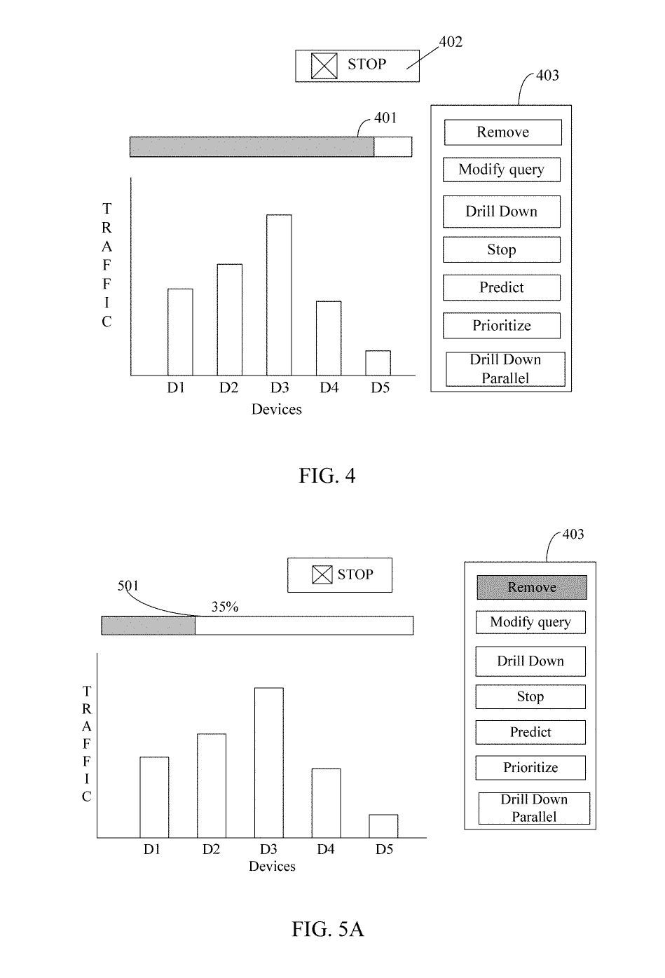

In an embodiment, the output module 212 provides the intermediate query execution status in the form of the visual trend for facilitating user interaction with the intermediate query execution status. FIG. 4 shows an exemplary user interface displaying the visual trend of the intermediate query execution for user interaction. In an embodiment, an electronic document showing the intermediate query execution of the query is displayed. The electronic document comprises a data scan progress trend referred by numeral 401, a stop button referred by numeral 402 and a visualization indicating the intermediate query execution status for the query. The stop button 402 is displayed proximal to the data scan progress trend 401. The visualization is displayed adjacent to the data scan progress trend 401. The visualization includes results corresponding to one or more nodes associated with the one or more queries and one or more data partitions of the one or more nodes. In the illustrated FIG. 4, the visualization indicates the intermediate query execution status of each of the network devices D1, D2, D3, D4 and D5 mentioned in the query.

In one implementation, the user interactions include interacting with the intermediate query execution status by providing one or more update query parameters and/or one or more update queries. The one or more updated query parameters and/or one or more update queries are provided upon choosing at least one of one or more query update options to update the query. In an embodiment, the one or more update options are displayed on the electronic document as electronic list referred by numeral 403 on the user interface. The one or more update options are displayed when the user moves an object in a direction on or near the displayed electronic document. The object includes, but is not limited to, finger and an input device. In an example, the input device includes, but is not limited to, stylus, pen shaped pointing device, keypad and any other device that can be used to input through the user interface. The movement of the object includes, but is not limited to, right click on the electronic document and long press on the electronic document. For example, when the user makes right click on the displayed intermediate query execution status, one or more update options are displayed. The one or more update options include, but are not limited to, remove, modify the query, drill down, stop, predict, prioritize, drill down parallel. When one of the one or more query update options except stop option 402 is selected, one or more update results are displayed. The one or more update results include, but are not limited to, node-wise results, results for updated number of nodes from one or more nodes, results of one or more nodes along with results of one or more sub-nodes or results of one of one or more nodes.

In an embodiment, at least one of the one or more updated query parameters and the one or more update queries are received by the update module 212 based on the one or more update options selected by the user during interaction.

Referring back to FIG. 2B, the execution module 213 executes the one or more queries. The execution module 213 performs updating flow of query execution of the one or more queries based on the one or more query parameters. The execution module 213 executes the one or more updated queries. In an embodiment, the updating flow of query execution of the one or more queries based on the one or more query parameters and executing the one or more updated queries is performed based on the one or more update options being selected. In an embodiment, the execution module 213 provides one or more updated intermediate query execution status to the user interface based on the updating flow of query execution of the one or more queries based on the one or more query parameters and executing the one or more updated queries.

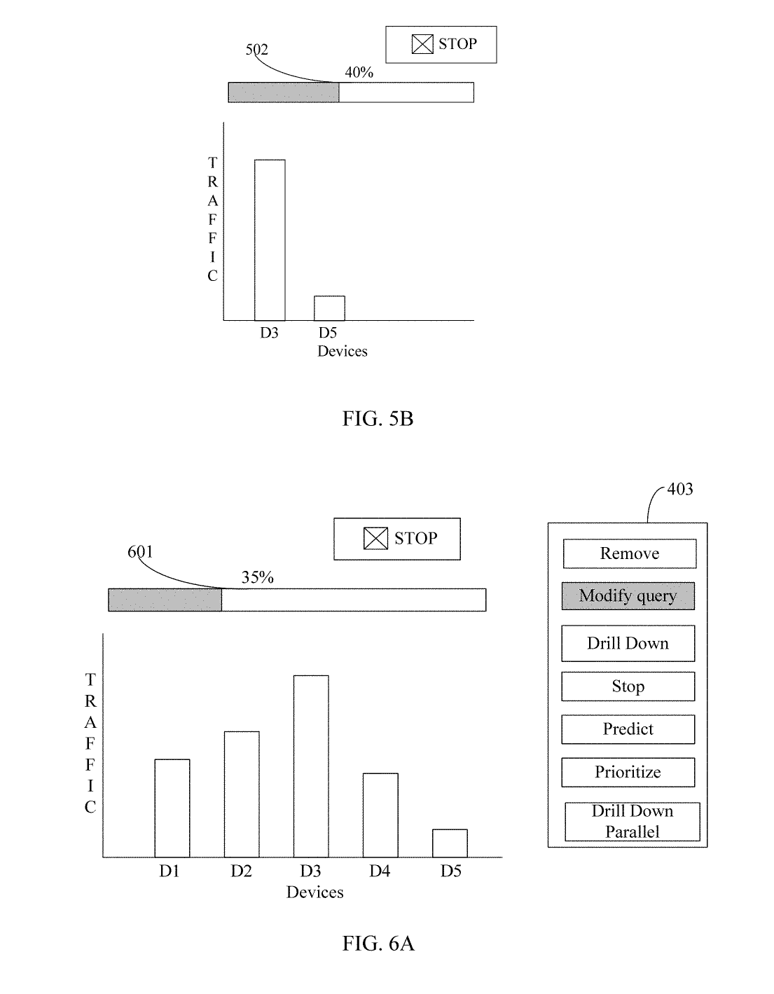

FIG. 5A shows an exemplary embodiment for updating flow of query execution based on the updated query parameters which comprises removing at least one of a part of the one or more queries, a part of the one or more nodes 216 and a part of the one or more data partitions 217. For example, consider the query 1 specifying to retrieve traffic volume of five network devices D1, D2, D3, D4 and D5. The visual trend of the intermediate query execution status for the execution of the query 1 is provided on the user interface. The data scan progress trend showing the query execution progress of 35% of the query 1 referred by 501 is displayed. The visual trend of the intermediate query execution status of each of the network devices D1, D2, D3, D4 and D5 is displayed. Now, considering the user wants to view traffic volume of network devices D3 and D5. Therefore, the user selects the network devices D1, D2 and D4 and makes a right click to select “remove” option. Upon selecting the remove option, the network devices D1, D2 and D4 are removed from being displayed on the user interface as shown in FIG. 5B. In an embodiment, the query execution of at least one of a part of the one or more queries, a part of the one or more nodes 216, a part of the one or more partitions 217, and the at least one sub-partitions are terminated when the remove option is selected. For example, the query execution of the network devices D1, D2 and D4 are terminated upon selecting the remove option for the network devices D1, D2 and D4. The query execution progress is updated to 40% for the query execution as referred by 502.

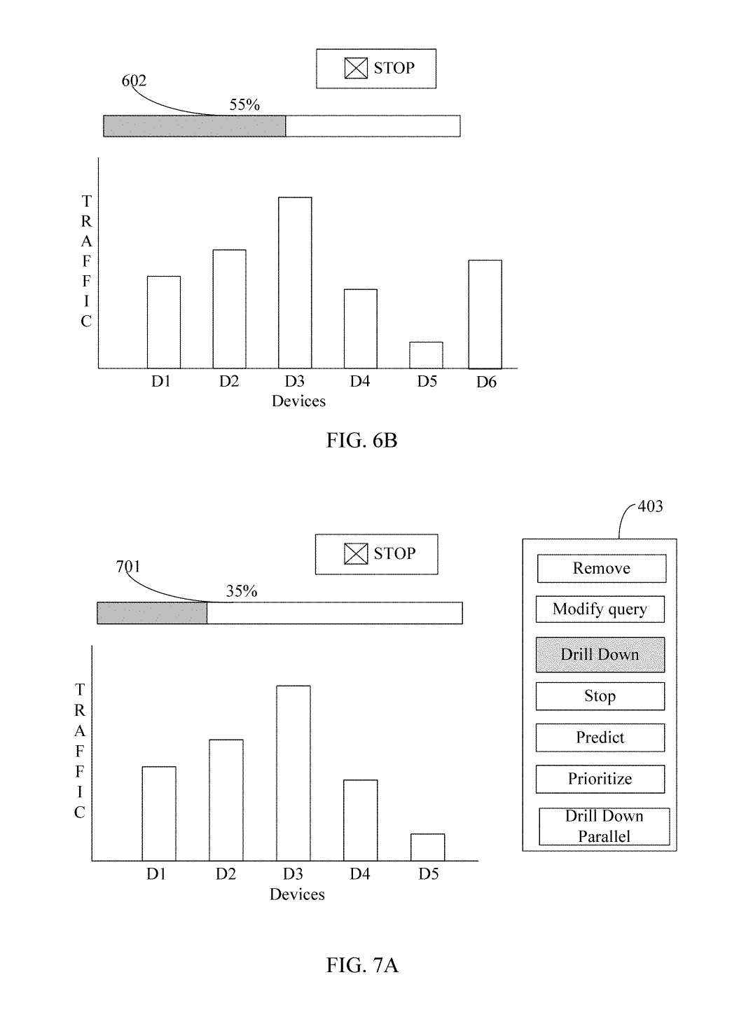

FIG. 6A shows an exemplary embodiment for updating flow of the query execution based on the updated query parameters comprises modifying a part of the one or more queries. In an embodiment, modifying include, but is not limited to, adding a part of the one or more queries. In one implementation, one or more query parameters of the one or more queries are updated to perform modification of the part of the one or more queries. For example, the visual trend of the intermediate query execution status of traffic volume of network devices D1, D2, D3, D4 and D5 are displayed on the user interface. Considering, the user wants to view visual trend of network device D6. Then, the user selects the option “modify” to add the visual trend of the network device D6. Now, the user is able to view the traffic volume status of the network devices D1, D2, D3, D4 and D5 along with traffic volume status of the network device D6 as shown in FIG. 6B. The query execution progress is updated to 55% as referred by 602.

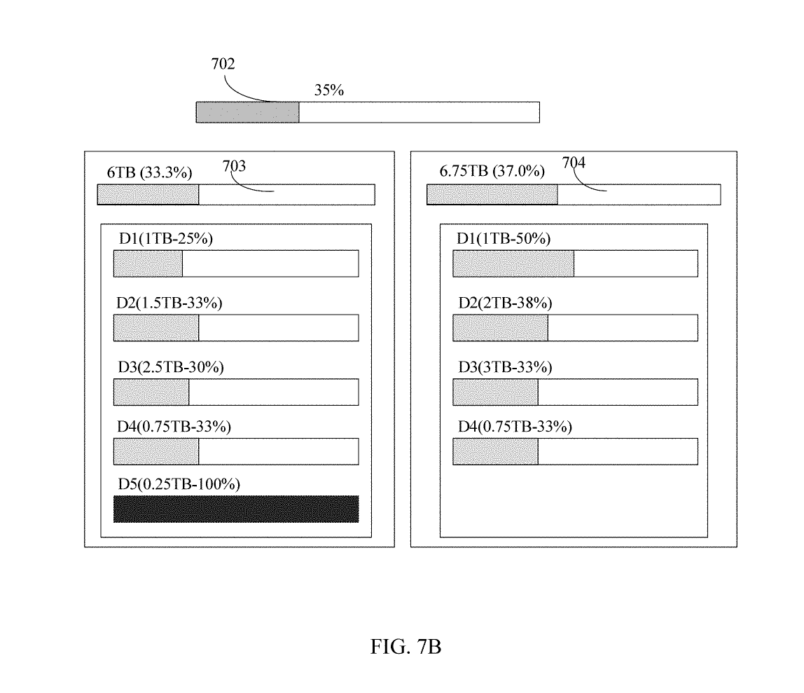

FIG. 7A illustrates an exemplary diagram where the user selects the option drill down to view intermediate query execution of the query in detail. FIG. 7B shows the detailed view of the intermediate query execution of the query. For example, the visual trend i.e. bar 702 is the intermediate query execution status of the query where the query execution progress is 35%. The visual trend i.e. bar 703 is the intermediate query execution status of the node 1 where the query execution progress is 33.3%. The bar 704 is the intermediate query execution status of the node 2, where the query execution progress is 37.0%. The bars of the network devices D1, D2, D3, D4 and D5 of the node 1 shows the query execution progress being 25%, 33%, 30%, 33% and 100%. The bars of the network devices D1, D2, D3 and D4 of the node 2 shows the query execution progress being 50%, 38%, 33% and 33%.

The option of stop is selected by clicking the stop button 402, then the query execution of at least one of a part of the one or more queries, a part of the one or more nodes and a part of the one or more data partitions is terminated for the query execution.

In an embodiment, the option of predict is selected. Then, a final query execution result is predicted based on the intermediate query execution status. The one or more parameters for predicting the result of the data scanning include, but are not limited to, a predetermined time period for the result of the data scanning is to be predicted, historical information on data scanned during the query execution, stream of data required to be scanned for the query execution, variance between an actual result of the query execution and the predicted result of query execution and information of data distributed across the one or more nodes 216 and the one or more partitions 217. In an embodiment, the prediction of the data scanning is achieved using methods which include, but is not limited to historical variance method, partition histogram method and combination of historical variance method, partition histogram method.

The historical variance method comprises two stages. The first stage comprises calculating a variance after each query execution and second stage comprises predicting using the historical variance to predict the final query execution result. The calculation of the variance after each query execution is illustrated herein. Firstly, upon every query execution, the variance between the intermediate result and the final query execution result are evaluated which are stored in the memory 205. Then, during query execution in real-time, the closest matching historical variance value is used based on comparison of the fields and filters/constraints of the current queries matching with fields and filters and constraints of the historical queries. Finally, the positive and negative variance values from the closest matching historical query are used to predict the query execution result for the current query at regular intervals.

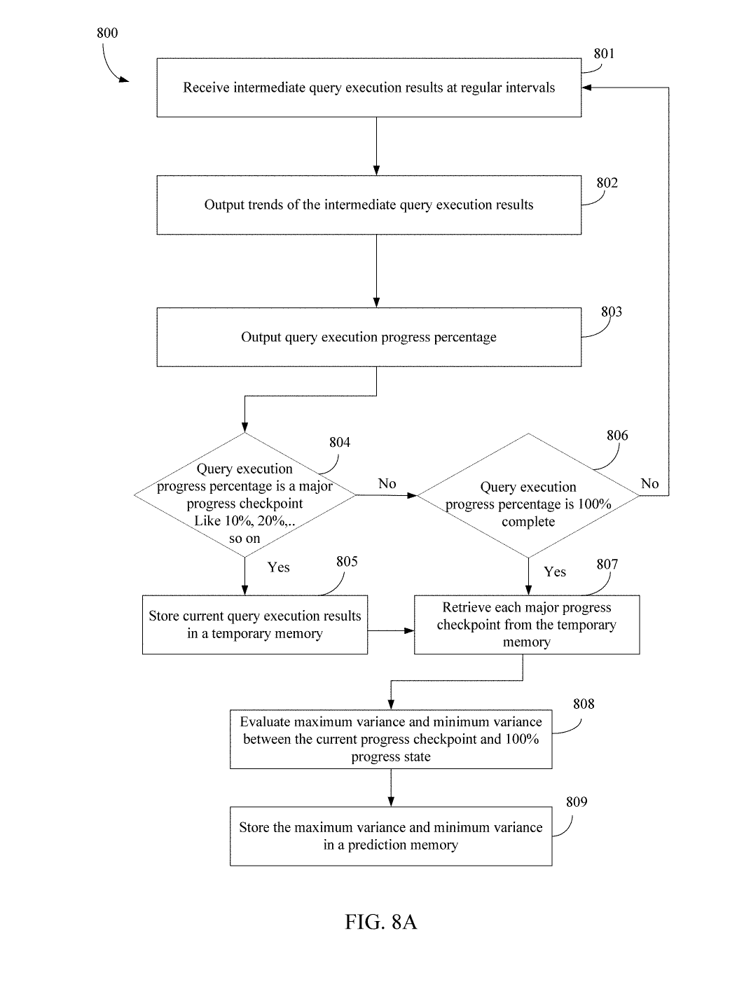

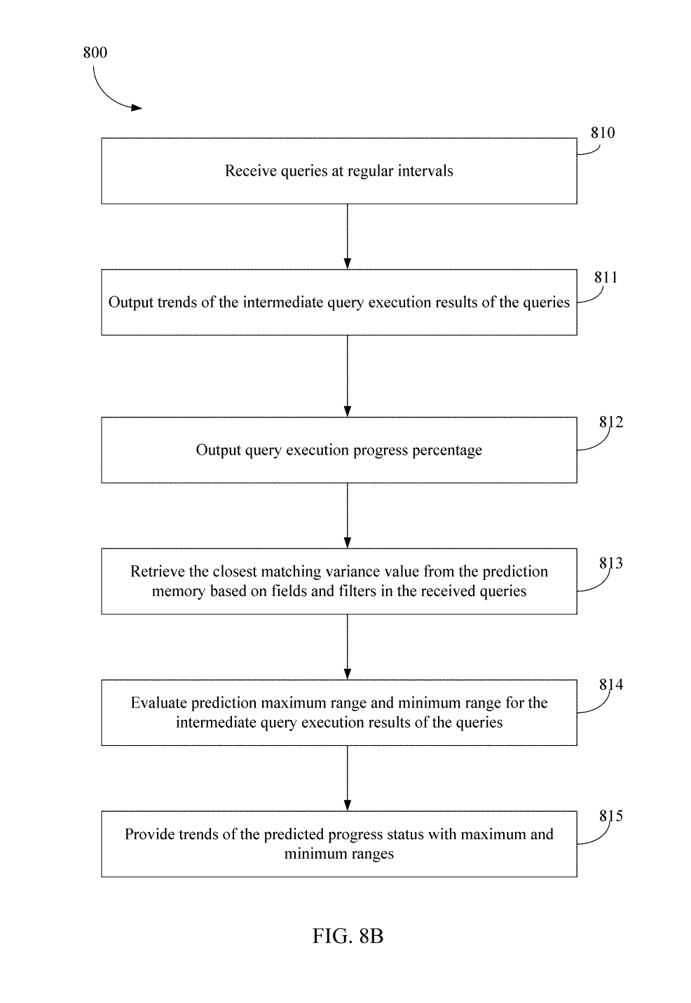

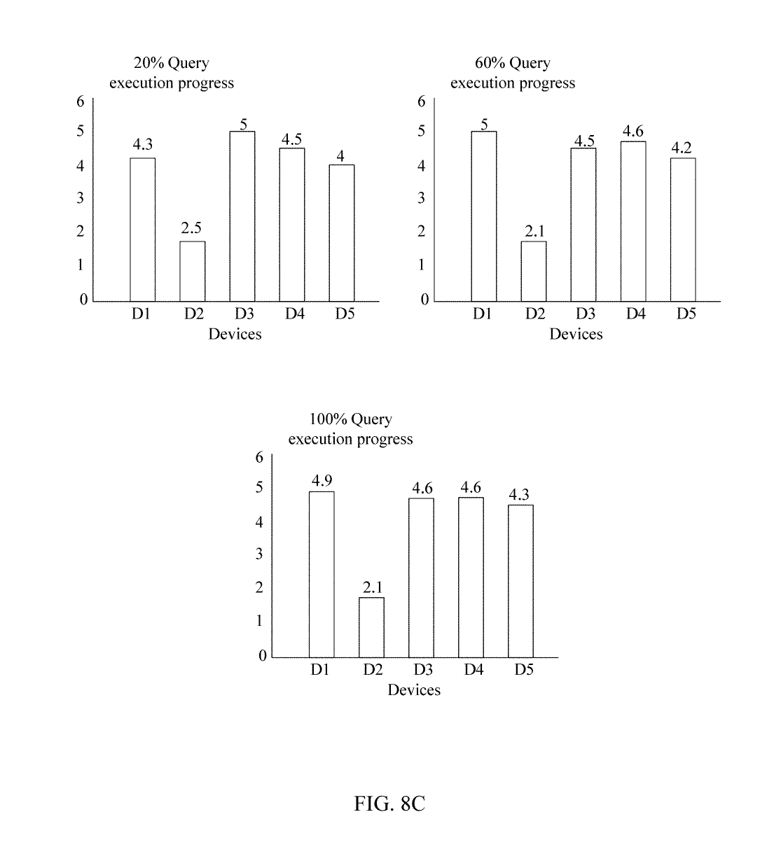

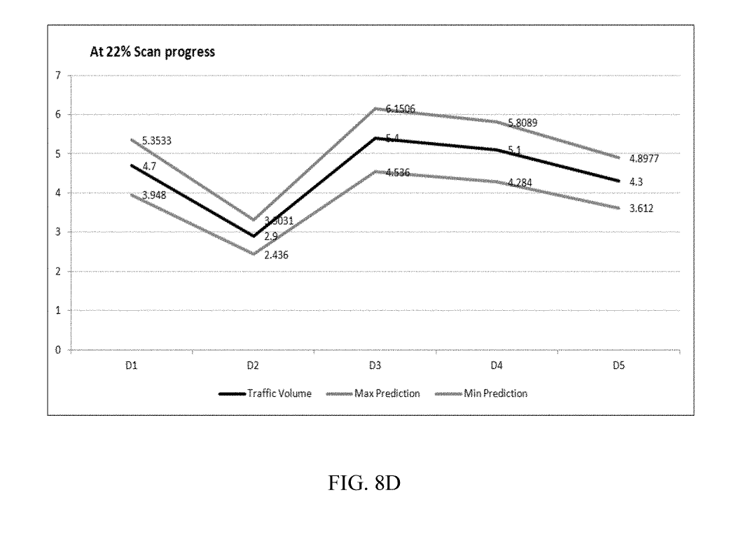

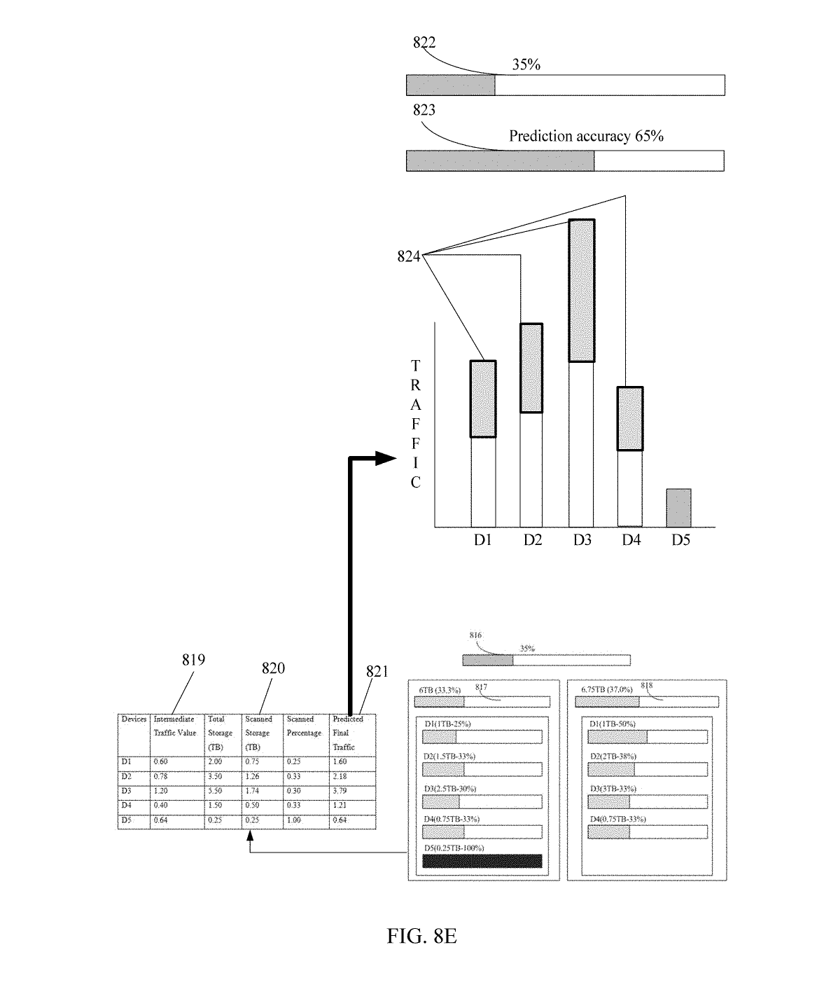

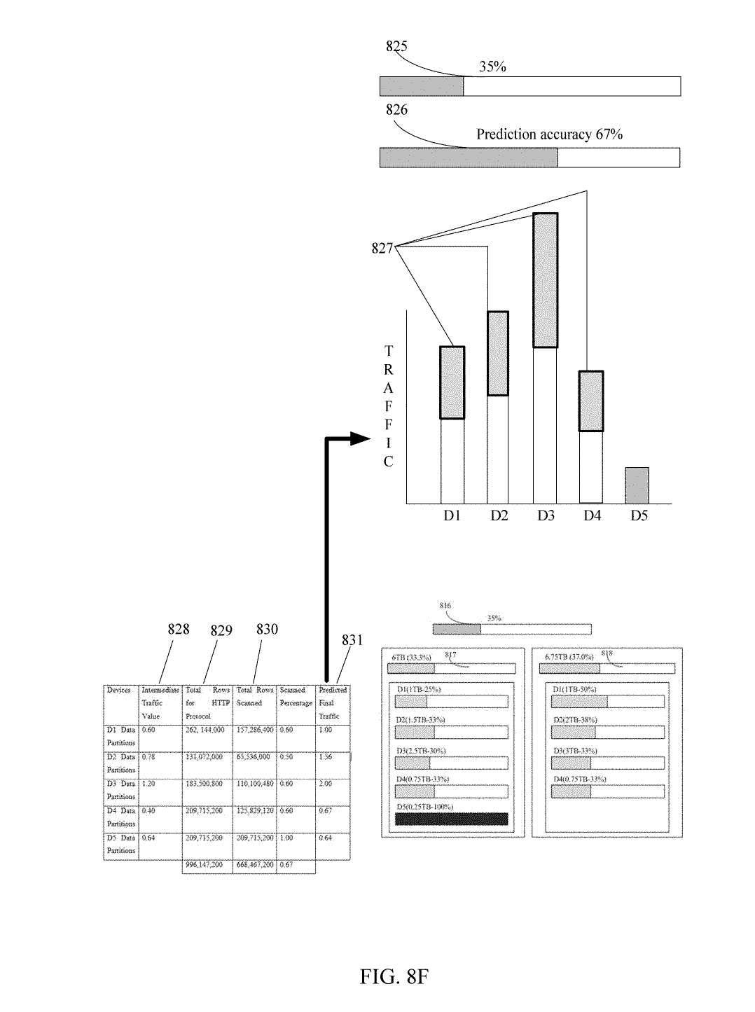

FIGS. 8A and 8B illustrate stages of the historic variance method for predicting final execution results. As illustrated in the FIGS. 8A and 8B, the method 800 comprises one or more blocks for predicting the final execution results. The method 800 may be described in the general context of computer executable instructions. Generally, computer executable instructions can include routines, programs, objects, components, data structures, procedures, modules, and functions, which perform particular functions or implement particular abstract data types.

The order in which the method 800 is described is not intended to be construed as a limitation, and any number of the described method blocks can be combined in any order to implement the method 800. Additionally, individual blocks may be deleted from the method 800 without departing from the scope of the subject matter described herein. Furthermore, the method 800 can be implemented in any suitable hardware, software, firmware, or combination thereof.

FIG. 8A illustrates the first stage of the historic variance method for prediction of the final query execution result.

At block 801, the intermediate execution result is received at regular intervals. Then, at block 802, trends of the intermediate query execution result is outputted. At block 803, the query execution progress percentage is outputted. At block 804, condition is checked whether the query execution progress percentage is a major progress checkpoint like 10%, 20% and so on. In case, the query execution progress percentage is a major progress checkpoint, then the current query execution results is stored in a temporary memory as illustrated in the block 805. In case, the query execution progress percentage is not a major progress checkpoint, then a condition is checked whether the query execution progress is 100% complete as illustrated in the block 806. In case, the query execution progress is not 100% complete, then the process goes to block 801 to retrieve the intermediate query execution results. In case, the query execution progress is 100% completed, then each major progress checkpoint is retrieved from the temporary memory as illustrated in the block 807. At block 808, maximum variance and minimum variance between current progress checkpoint and 100% progress state is evaluated. The maximum variance and the minimum variance are stored in a prediction memory as illustrated in the block 809.

The second stage of predicting using the historical variance to predict the final query execution result is illustrated herein. FIG. 8B illustrates the second stage of the historic variance method 800 for prediction of the final query execution result. At block 810, stream of queries are received at regular intervals. At block 811, trends of the intermediate query execution result of the queries is outputted. At block 812, the query execution progress percentage of the queries is outputted. Based on the fields and filters of the queries, the closest matching variance value from the prediction memory is retrieved as illustrated in the block 813. The closest matching variance value is used to evaluate prediction maximum and minimum range for the intermediate query execution results of the queries as illustrated in the block 814. At block 815, the trends of predicted progress status along with the maximum and minimum range is provided on the user interface.

FIG. 8C shows an example diagram for predicting a final query execution result. Consider, the historical data scanning for the query execution of historic query data. At 20% of the query execution, the query execution progress of the devices D1, D2, D3, D4 and D5 was 4.3, 2.5, 5, 4.5 and 4 units. Then, at 60% of the query execution, the query execution progress of the devices D1, D2, D3, D4 and D5 was 5, 2.1, 4.5, 4.6 and 4.2. Then, at 100% of the query execution, the query execution progress of the query execution progress of the devices D1, D2, D3, D4 and D5 was 4.9, 2.1, 4.6, 4.6 and 4.3 units. From the analysis, the device D1 has maximum positive variance from 20% to 100% query execution which is evaluated (4.9−4.3)/4.3*100=13.0%. From the analysis, the device D2 has maximum negative variance from 20% to 100% query execution which is evaluated (2.1−2.5)/2.5*100=−16.0%. From the analysis, the device D5 has maximum positive variance from 60% to 100% query execution which is evaluated (4.3−4.2)/4.2*100=2.3%. From the analysis, the device D1 has maximum negative variance from 60% to 100% query execution which is evaluated (4.9−5)/4.9*100=−2.0%. The positive and negative variance values of percentage of the data scanning are stored in the memory 205 for use in predicting the final query execution results in real-time. The table 1 shows the maximum and minimum variances stored in the prediction memory.

| | Fields and | | Positive or | Negative or |
|---|---|---|---|---|
| | Filters of the | | maximum | minimum |
| Query | query | Progress | variance | variance |
| 1 | Traffic Volume | 20% | D1 = 13.0% | D2 = −16.0% |
| | | 60% | D5 = 2.3% | D1 = −2.0% |

Consider, at 22% data scan progress, the closest percentage of data scan is 20% whose positive and negative variance values are used for predicting the data scanning results at 22% of data scan. That is, the maximum positive variance of 13.0% and maximum negative variance of −16% are used for predicting. The predicted result with maximum and minimum prediction range is shown in FIG. 8D.

The partition histogram method for predicting a final query execution result is explained herein. In an embodiment, the partition histogram is created based on the data statistics, for example size, and number of rows with records. The distribution information of the data across various partitions is maintained as a histogram. The partition histogram method comprises predicting the final query execution result by receiving intermediate query execution status of the one or more queries. Then, fields in the one or more queries and distribution information of the data across the one more data partitions 217 are used to evaluate the final predicted result for the one or more queries. The predicted final result is provided as a predicted visual trend comprising an intermediate predicted result and prediction accuracy for the one or more queries. An example for predicting the final query execution result is illustrated herein by referring to FIG. 8E. The intermediate traffic value of each of the network devices D1, D2, D3, D4 and D5 referred as 819 in the table are obtained from the intermediate query execution status. Considering, the intermediate traffic value of network devices D1, D2, D3, D4 and D5 evaluated as 0.60, 0.78.1.20, 0.40 and 0.64. From the intermediate query execution status, the scanned storage of each of the network devices is obtained which is referred as 820. For example, the scanned storage of network device D1 is 0.75 TB, network device D2 is 1.26 TB and so on. Using the partition histogram method, the predicted final traffic of the devices is 1.60 for D1, 2.18 for D2, 3.79 for D3, 1.21 for D4 and 0.64 for D5 referred as 821. The predicted final traffic values are represented as bar chart as shown in the FIG. 8e. The predicted accuracy for the query is referred as 823 and the predicted bar is referred as 824 in the FIG. 8e.

FIG. 8F illustrates predicting a final execution result based on filters of the one or more queries. For example, Considering, a query with filter mentioned to retrieve traffic volume of each network device D1, D2, D3, D4 and D5 as HTTP Protocol. That is, the query mentions the filter as “HTTP Protocol” to retrieve the traffic volume of network devices using HTTP Protocol. Then, based on the intermediate query execution status, the intermediate traffic value of device D1 is 0.60, device D2 is 0.78 and so on as referred by 828. The total number of records having data matching the filer “HTTP Protocol” in device D1 is 262,144,000 as referred by 829. The total number of records having data matching the filer “HTTP Protocol” in device D2 is 131,072,000 and so on as referred by 829. The total number of records scanned for the device D1 is 157,286,400, for device D2 is 65,536,000 and so on as referred by 830. From the total number of records and total number of matching records for HTTP protocol found in data scanning, the scanned percentage evaluated for the device D1 is 0.60, D2 is 0.50 and so on. Using the partition histogram method, the predicted final traffic for device D1 is 1.00, D2 is 1.56 and so on as referred by 831. From the predicted final traffic, the bar chart for the query is represented on the user interface. The prediction accuracy is 67% referred as 826 for the query having query execution progress as 35% referred as 825. The prediction accuracy is evaluated based on the total number of records matching HTTP protocol of all the devices and total number of records for HTTP protocol for all devices found in data scanning done so far. For example, the total number of records matching the filter HTTP protocol of all the devices is 996,147,200. The total number of matching records for HTTP protocol for all the devices found in the data scanning so far is 668,467,200. The prediction accuracy is 0.67 which is evaluated by dividing the total number of records scanned being 668,467,200 by the total number of records being 996,147,200.

The combination of historical variance method, partition histogram method comprises checking whether prediction accuracy is obtained from the historical variance method. In case, the prediction accuracy is obtained from the historical variance method, then the prediction accuracy using both the historical variance method and the partition histogram method is obtained. In case, the prediction accuracy is not obtained from the historical variance method, then the prediction accuracy is obtained using only the partition histogram method. In case, the queries mentions sum or count of records to be retrieved, then a weightage is given to the partition histogram method for obtaining prediction accuracy. In case, the queries mention average of records to be retrieved, then a weightage is given to the historical variance method for obtaining prediction accuracy.

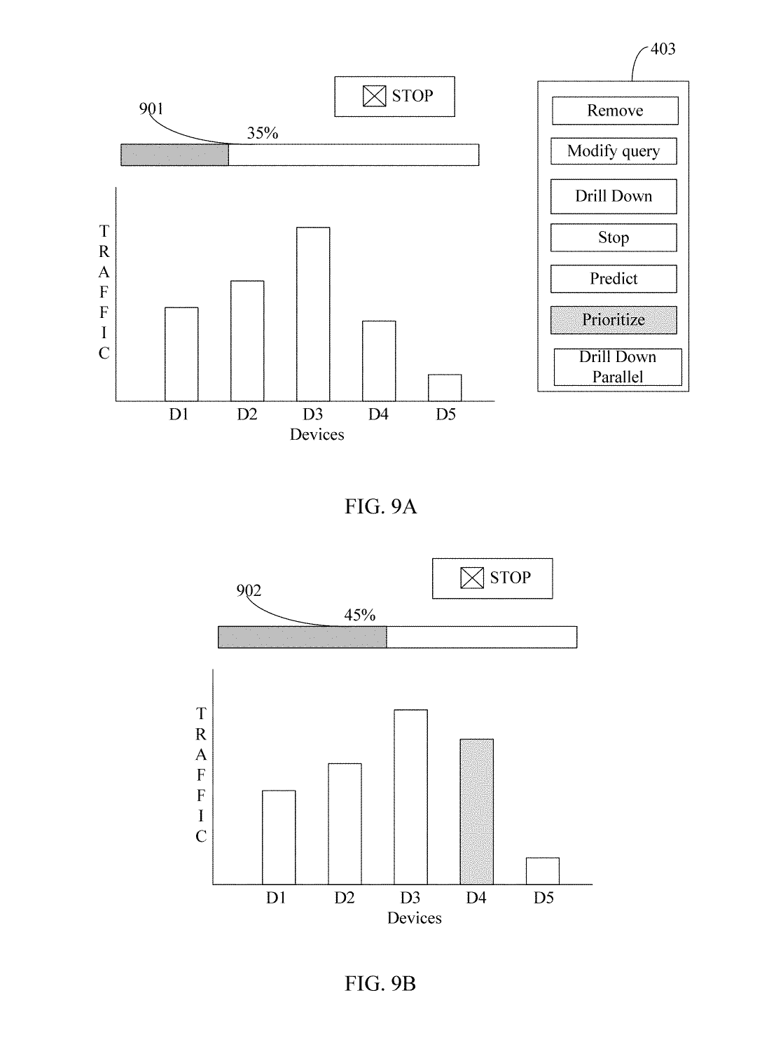

FIG. 9A illustrates prioritizing the query execution of at least one of the one or more nodes, one or more partitions and at least one sub-partition by selection the option of prioritize. For example, in case the priority option is selected to increase the query execution speed of the device D4. Then, the query execution of device D4 is prioritized by allocating extra CPU, memory etc. and other resource for the query execution. As shown in FIG. 9B, the intermediate results at 45% scan level shows significant change in traffic volume of the device D4 compared to other devices due to increased priority of scan for the device D4.

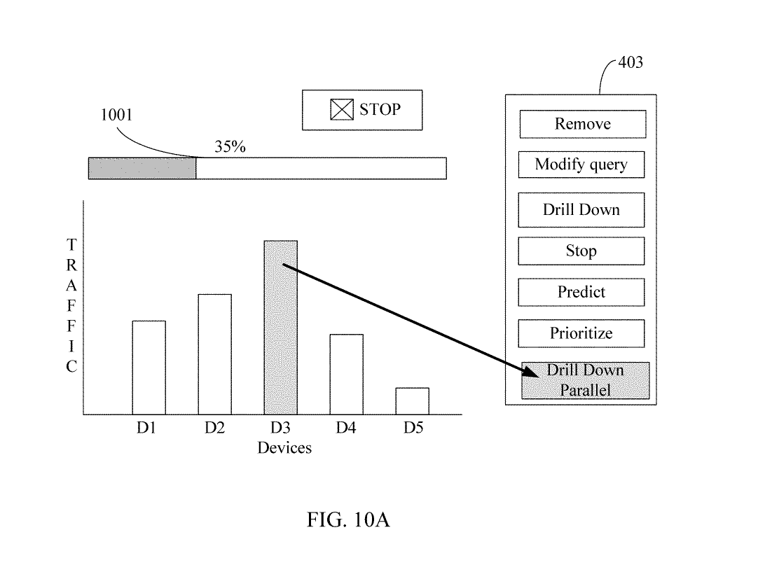

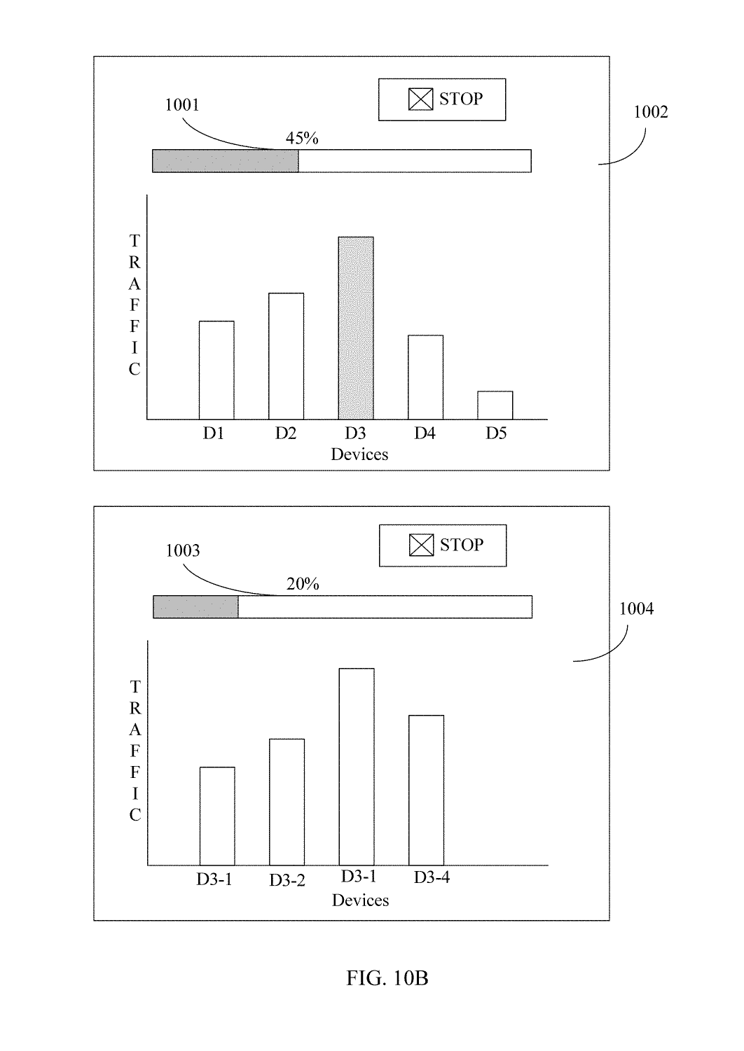

FIG. 10A illustrates drill down of the intermediate query execution of the one or more queries along with the updated queries. In an embodiment, the one or more queries and updated queries are executed parallelly. Upon executing parallelly, intermediate query execution status of the one or more queries and the updated queries are displayed parallelly. That is, parallel view of the intermediate query execution status of the one or more queries and the updated queries are provided on the user interface. For example, when the option of drill down parallel is selected, then the visual trends of the intermediate query execution status of the sub-devices of one of the network devices along with the visual trends of the intermediate query execution status of the one or more network devices is displayed. For example, in case the option of drill down parallel is selected on the network device D3, then the intermediate query execution status of the device D3 along with the intermediate query execution status of the sub-devices i.e. D3-1, D3-2, D3-3, D3-4 of the device D3 is displayed in a form of visual trend as shown in FIG. 10B. The numeral 1002 shows the intermediate query execution of the query showing traffic volume of the network devices D1, D2, D3, D4 and D5. The numeral 1004 shows the intermediate query execution of the sub-devices of the device D3 where numeral 1003 represents the query execution progress of 70% of the device D3.

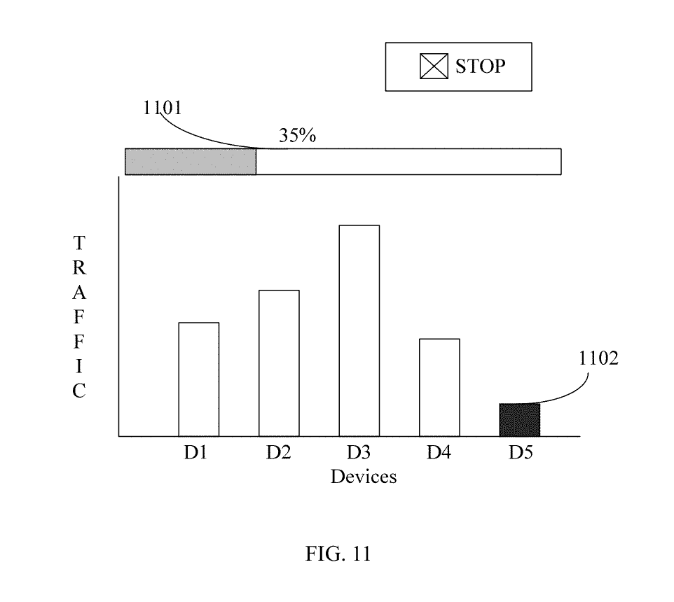

FIG. 11 shows an exemplary diagram illustrating marking of the visual trend of the intermediate query execution status upon completion of execution a part of the one or more queries. For example, the bar of the network device D5 is marked i.e. highlighted as referred to numeral 1102 when the query execution for the D5 is completed.

In one implementation, the predicted visual trend and prioritized visual trend is also marked. In an embodiment, the marking comprises highlighting and/or lowlighting the visual trends, the predicted visual trends and prioritized visual trend.

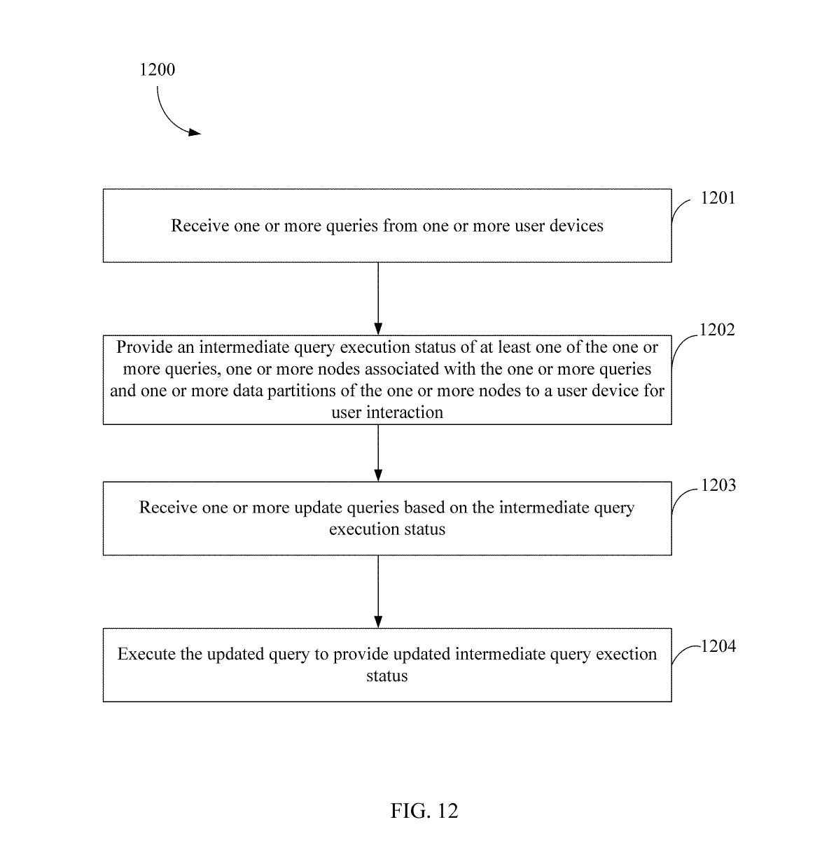

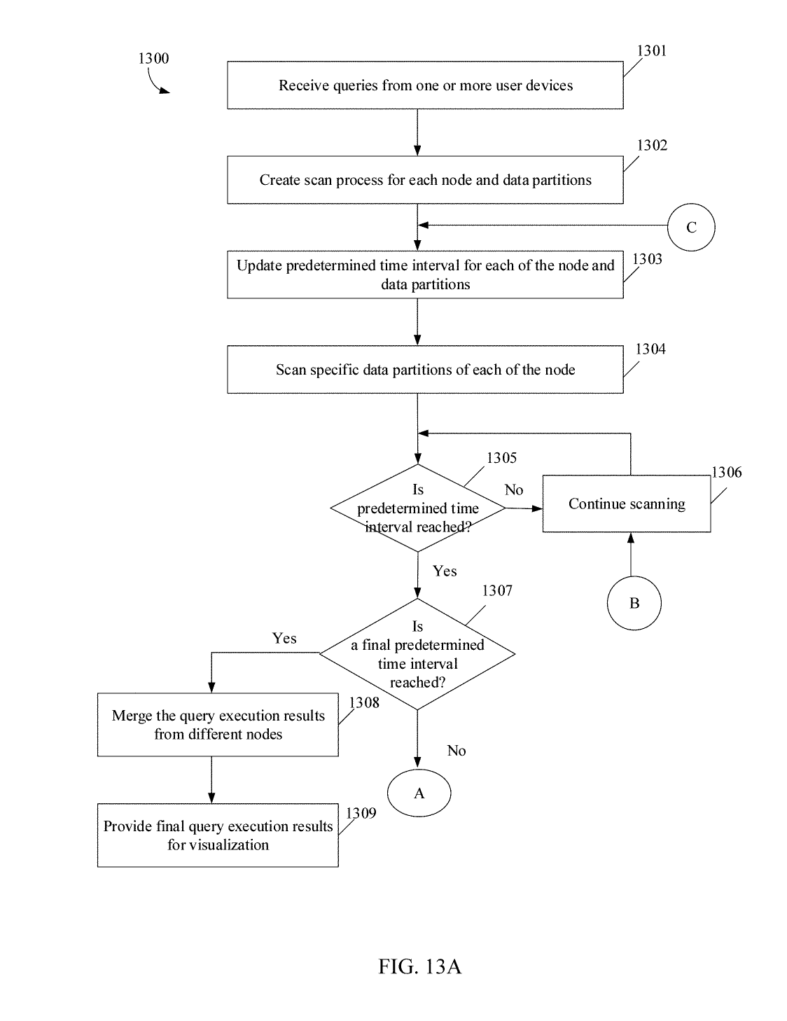

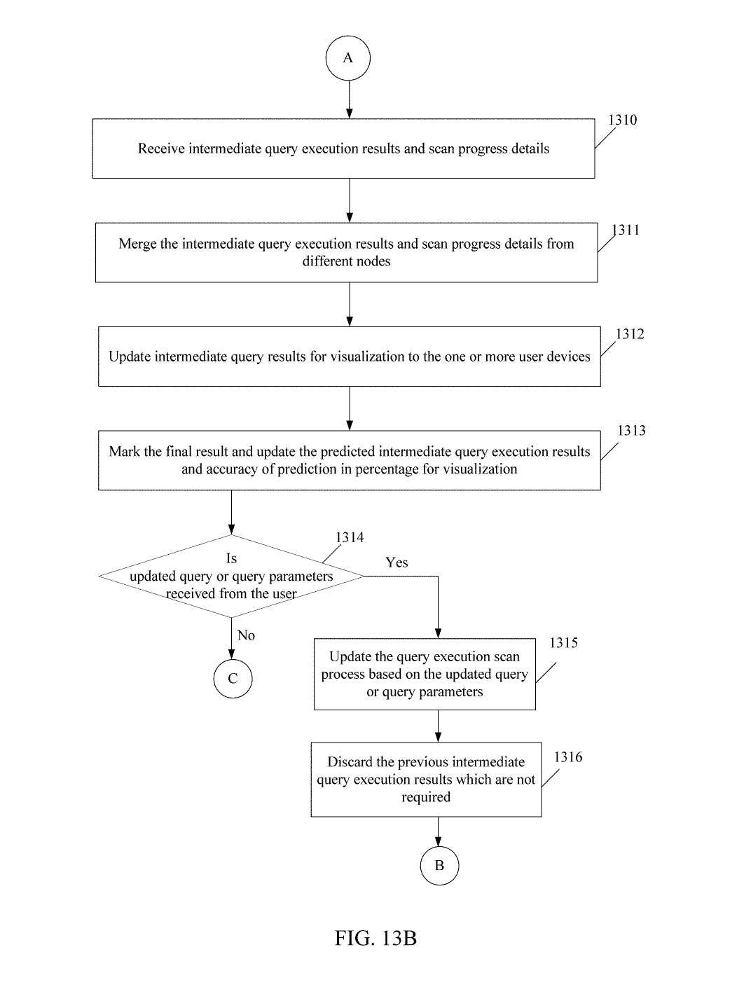

As illustrated in FIGS. 12 and 13, the method 1200 and 1300 comprises one or more blocks for optimizing query execution by the query processing server 202. The method 1200 and 1300 may be described in the general context of computer executable instructions. Generally, computer executable instructions can include routines, programs, objects, components, data structures, procedures, modules, and functions, which perform particular functions or implement particular abstract data types.

The order in which the method 1200 and 1300 is described is not intended to be construed as a limitation, and any number of the described method blocks can be combined in any order to implement the method 1200 and 1300. Additionally, individual blocks may be deleted from the method 1200 and 1300 without departing from the scope of the subject matter described herein. Furthermore, the method 1200 and 1300 can be implemented in any suitable hardware, software, firmware, or combination thereof

FIG. 12 illustrates a flowchart of method 1200 for optimizing query execution in accordance with some embodiments of the present disclosure.

At block 1201, one or more queries are received by the receiving module 211 of the query processing server 202 from the one or more user devices 201. In an embodiment, the one or more queries are executed by the data scanner 218 for the query execution. The intermediate query execution status is provided by the data scanner 218 the receiving module 211.

At block 1202, the intermediate query execution status of at least one of the one or more queries, one or more nodes 216 for executing the one or more queries and one or more data partitions 217 of the one or more nodes 216 is provided to the user device for user interaction by the query processing server 202. In an embodiment, the intermediate query execution status is provided in the form of the visual trend. The intermediate query execution status is provided based on the query execution of the one or more queries.

At block 1203, one or more updated query parameters for the one or more queries and one or more update queries are received from the user using the one or more user devices 201 based on the interaction on the intermediate query execution status. The execution module 213 performs updating flow of query execution of the one or more queries based on the one or more query parameters to provide an updated intermediate query execution status. The updating flow of query execution of the one or more queries based on the one or more query parameters comprises terminating the query execution of at least one of a part of the one or more queries, a part of the one or more nodes 216, a part of the one or more partitions 217 and the at least one sub-partition. The execution of the one or more queries based on the one or more updated query parameters comprises prioritizing the query execution of at least one of a part of the one or more queries, a part of the one or more nodes and a part of the one or more data partitions. The execution of the one or more queries based on the one or more updated query parameters comprises executing a part of the one or more queries. In an embodiment, the part of the one or more queries is added by the user. The execution module 213 performs execution of the one or more updated queries to provide an updated intermediate query execution status of the query execution.The execution of the one or more updated queries comprises executing parallelly the one or more updated queries along with the one or more queries. In an embodiment, the visual trend of the intermediate query execution results is marked upon completion of a part of the query execution.

At block 1204, the one or more queries based on the one or more updated query parameters and the one or more updated queries are executed by the execution module 213 to provide updated intermediate query execution status to the user interface in the form of updated visual trend. In an embodiment, the visual trend of the the one or more queries, the one or more nodes 216 and the one or more data partitions 217 upon completion of the query execution is marked. In one implementation, the predicted visual trend and prioritized visual trend is also marked. In an embodiment, the marking comprises highlighting and/or lowlighting the visual trends, the predicted visual trends and prioritized visual trend.

FIGS. 13A and 13B illustrate a flowchart of method 1300 for providing intermediate query execution status and query execution progress details in accordance with some embodiments of the present disclosure.

Referring to FIG. 13A, at block 1301, the queries from the one or more user devices are received by the query processing server 202. In an embodiment, the queries are raised by the user using the one or more user devices 201.

At block 1302, the scan process for each of the nodes and the data partitions are created. In an embodiment, the storage status of each of the nodes and data partitions is accessed during the scan process.

At block 1303, the predetermined time interval for each of the nodes and the data partitions is updated. For example, the predetermined time interval is 60 seconds for which the scanning is required to be processed. The scanning performed for 60 seconds is updated.

At block 1304, specific data partitions of each of the nodes are scanned to obtain query result.

At block 1305, a check is performed whether the predetermined time interval is reached. If the predetermined time interval is not reached, then the process goes to block 1306 via “No” where the scanning process is continued. If the predetermined time interval is reached, then the process goes to block 1307 via “Yes” where a condition is checked whether a final predetermined time interval is elapsed. If the final predetermined time interval is elapsed then the process goes to block 1308 via “Yes” where query execution results from different nodes are merged. Then, at block 1309, final query execution results are provided to the user for visualization. If the final predetermined time interval is not elapsed then the process goes to process ‘A’.

Referring to FIG. 13B, at block 1310, the intermediate query execution results and scan progress details are received.

At block 1311, the intermediate query execution results and scan progress details from different nodes are merged.

At block 1312, the intermediate query execution results are updated to the one or more user devices 201.

At block 1313, the final result is marked. Also, the predicted intermediate query execution results and accuracy of the prediction in percentage value are provided to the one or more user devices 201.

At block 1314, a check is performed whether updated queries and/or query parameters are received from the user. If the updated queries and/or query parameters are received, then the process goes to block 1315 where the query execution scan process is updated based on the updated queries and/or query parameters. Then, at block 1316, previous intermediate query execution results which are not required are discarded. Then, the process is continued to ‘B’. In the alternative, if the updated queries and/or query parameters are not received then the process goes back to process ‘C’.

Additionally, advantages of present disclosure are illustrated herein.

Embodiments of the present disclosure provide display of intermediate query execution status which improves the analysis and query execution.

Embodiments of the present disclosure eliminate waiting for completion of entire scanning process for viewing the query execution results.

Embodiments of the present disclosure provide user interaction based on the intermediate query execution status to update the queries for optimizing the query execution.

Embodiments of the present disclosure provide intermediate query execution status based on the rows being scanned, size and rate of data being scanned which eliminates the limitation of providing query execution status only based on the number of rows being scanned.

Embodiments of the present disclosure provide prediction on the query execution results for the nodes, partitions and sub-partition based on the analysis of the intermediate scanning status.

Embodiments of the present disclosure eliminate wastage of query execution time and system resource being used for the query execution. The wastage is reduced because the queries can be updated as per user's requirement based on the intermediate query execution status. For example, the user can terminate the query execution once the query execution reaches to the satisfactory level. The user can use predicted results to terminate or prioritize the query execution when the prediction accuracy is high. Additionally, based on intermediate results, unwanted data parameters can be removed during the query execution which saves computation time and process.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (compact disc read-only memories (CD-ROMs), digital versatile discs (DVDs), optical disks, etc.), volatile and non-volatile memory devices (e.g., electrically erasable programmable read-only memories (EEPROMs), read-only memories (ROMs), programmable read-only memories (PROMs), RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, PGA, ASIC, etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the disclosure, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIGS. 8A, 8B, 12, 13A, and 13B show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the following claims.

What is claimed is:

1. A method for optimizing query execution comprising:
receiving, by a query processing server, one or more queries from one or more user devices;
providing, by the query processing server, an intermediate query execution status of at least one of the one or more queries, one or more nodes for executing the one or more queries and one or more data partitions of the one or more nodes to a user device for user interaction, wherein the intermediate query execution status is provided based on the query execution of the one or more queries;
receiving, by the query processing server, one or more updated queries based on the intermediate query execution status from the one or more user devices; and
executing the one or more updated queries to provide an updated intermediate query execution status.

2. The method of claim 1, wherein the intermediate query execution status is selected from a group comprising intermediate query execution results and a query execution progress of the one or more queries, the one or more nodes and the one or more data partitions for the query execution.

3. The method of claim 2 further comprising marking a visual trend of the intermediate query execution results upon completion of execution of a part of the one or more queries.

4. The method of claim 2, wherein the intermediate query execution status is provided based on one or more parameters selected from a group comprising a predetermined time interval, number of rows being scanned, size of data being scanned, and rate of data being scanned.

5. The method of claim 1, further comprising predicting a final result of the query execution for at least one of the one or more queries, the one or more nodes and the one or more data partitions based on one or more parameters.

6. The method of claim 4, wherein the one or more parameters for predicting the final result of the query execution is selected from a group comprising a predetermined time period for the result of the data scanning is to be predicted, historical information on data scanned during the query execution, stream of data required to be scanned for the query execution, variance between an actual result of the query execution and the predicted result of query execution, and information of data distributed across the one or more nodes and the one or more query processing devices.

7. The method of claim 6, wherein the intermediate query execution status, the updated intermediate query execution status and the final result of the query execution are provided in a form of a visual trend.

8. The method of claim 1, further comprising providing a visual trend of an intermediate query execution status related to at least one sub-partition of the one or more data partitions to the user device.

9. A method for optimizing query execution comprising:
receiving, by a query processing server, one or more queries from one or more user devices;
providing, by the query processing server, an intermediate query execution status of at least one of the one or more queries, one or more nodes for executing the one or more queries and one or more data partitions of the one or more nodes to a user device for user interaction, wherein the intermediate query execution status is provided based on the query execution of the one or more queries;
receiving, by the query processing server, one or more updated query parameters for the one or more queries based on the intermediate query execution status from the one or more user devices; and
updating flow of the query execution of the one or more queries based on the one or more updated query parameters to provide an updated intermediate query execution status.

10. The method of claim 9, wherein updating the flow of the query execution of the one or more queries based on the one or more updated query parameters comprises at least one of:
terminating the query execution of at least one of a part of the one or more queries, a part of the one or more nodes and a part of the one or more data partitions;
prioritizing the query execution of at least one of a part of the one or more queries, a part of the one or more nodes and a part of the one or more data partitions; and
executing a part of the one or more queries, wherein the part of the one or more queries is selected by the user.

11. A query processing server for optimizing query execution, comprising:
an input/output (I/O) interface configured to:
receive one or more queries from one or more user devices; and
provide an intermediate query execution status of at least one of the one or more queries, one or more nodes for executing the one or more queries and one or more data partitions of the one or more nodes to a user device for user interaction, wherein the intermediate query execution status is provided based on the query execution of the one or more queries;
a processor configured to:
receive one or more updated queries based on the intermediate query execution status; and
execute the one or more updated queries to provide an updated intermediate query execution status.

12. The query processing server of claim 11, wherein the intermediate query execution status is selected from a group comprising intermediate query execution results and a query execution progress of the one or more queries, the one or more nodes and the one or more data partitions for the query execution.

13. The query processing server of claim 11, wherein the intermediate query execution status is provided based on one or more parameters selected from a group comprising a predetermined time interval, number of rows being scanned, size of data being scanned, and rate of data being scanned.

14. The query processing server of claim 11, wherein the processor is configured to mark a visual trend of the intermediate query execution results upon completion of execution of a part of the one or more queries.

15. The query processing server of claim 11, wherein the processor is further configured to predict a final result of the query execution for at least one of the one or more queries, the one or more nodes and the one or more data partitions based on one or more parameters.

16. The query processing server of claim 15, wherein the processor predicts the final result of the query execution using one or more parameters selected from a group comprising a predetermined time period for the result of the data scanning is to be predicted, historical information on data scanned during the query execution, stream of data required to be scanned for the query execution, variance between an actual result of the query execution and the predicted result of query execution, and information of data distributed across the one or more nodes and the one or more query processing devices.

17. The query processing server of claim 11, wherein the I/O interface provides a visual trend of an intermediate query execution status related to at least one sub-partition of the one or more data partitions to the user device.

18. A query processing server for optimizing query execution, comprising:
an input/output (I/O) interface configured to:
receive one or more queries from one or more user devices; and
provide an intermediate query execution status of at least one of the one or more queries, one or more nodes for executing the one or more queries and one or more data partitions of the one or more nodes to a user device for user interaction, wherein the intermediate query execution status is provided based on the query execution of the one or more queries;
a processor configured to:
receive one or more updated query parameters for the one or more queries based on the intermediate query execution status; and
update flow of the query execution of the one or more queries based on the one or more updated query parameters to provide an updated intermediate query execution status.

19. The query processing server of claim 18, wherein the processor updates the flow of the query execution of the one or more queries by performing at least one of:
terminating the query execution of at least one a part of the one or more queries, a part of the one or more nodes and a part of the one or more data partitions;
prioritizing the query execution of at least one of a part of the one or more queries, a part of the one or more nodes and a part of the one or more data partitions; and
executing a part of the one or more queries, wherein the part of the one or more queries is selected by the user.

20. A non-transitory computer readable medium including operations stored thereon that when processed by at least one processing unit cause a query processing server to perform one or more actions by performing the acts of:
receiving one or more queries from one or more user devices;
providing an intermediate query execution status of at least one of the one or more queries, one or more nodes for executing the one or more queries and one or more data partitions of the one or more nodes to a user device for user interaction, wherein the intermediate query execution status is provided based on the query execution of the one or more queries;
receiving one or more updated queries based on the intermediate query execution status; and
executing the one or more updated queries to provide an updated intermediate query execution status.

21. A non-transitory computer readable medium including operations stored thereon that when processed by at least one processing unit cause a query processing server to perform one or more actions by performing the acts of:
receiving one or more queries from one or more user devices;
providing an intermediate query execution status of at least one of the one or more queries, one or more nodes for executing the one or more queries and one or more data partitions of the one or more nodes to a user device for user interaction, wherein the intermediate query execution status is provided based on the query execution of the one or more queries;
receiving one or more updated query parameters for the one or more queries based on the intermediate query execution status; and
updating flow of the query execution of the one or more queries based on the one or more updated query parameters to provide an updated intermediate query execution status.
